(19) United States
(12) Patent Application Publication
(10) Pub. No.: US 2024/0416731 A1
(43) Pub. Date: Dec. 19, 2024

(54) SUN VISOR ASSEMBLY FOR A VEHICLE INTERIOR AND MOTOR VEHICLE COMPRISING SUCH A SUN VISOR ASSEMBLY

(71) Applicant: BOS GmbH & Co. KG, Ostfildern (DE)

(72) Inventors: Markus HINTENNACH, Uhingen (DE); Carolin GÜNTHER, Reutlingen (DE); Jürgen SALEWSKI, Wendlingen (DE)

(21) Appl. No.: 18/712,411

(22) PCT Filed: Nov. 22, 2022
(86) PCT No.: PCT/EP2022/082719

§ 371 Date: May 22, 2024

(30) Foreign Application Priority Data
Nov. 23, 2021 (DE) 10 2021 213 179.4

(51) Int. Cl. B60J 3/04; B60J 3/02

(52) U.S. Cl. CPC B60J 3/04; B60J 3/0204

(57) ABSTRACT

A sun visor assembly for a vehicle interior and motor vehicle. The sun visor assembly has a visor arranged to be displaceable between a functional position and a resting position. The visor part has a dimensionally stable frame which surrounds at least one light-transmitting, flexible carrier layer, on which an electrically activatable light-inhibiting functional layer is extensively applied.

The invention relates to a sun visor assembly for a vehicle interior with a visor part which is arranged to be displaceable between a functional position and a resting position and has an electrically activatable light-inhibiting functional layer. The invention additionally relates to a motor vehicle having at least one such sun visor assembly.

A passenger vehicle is known from WO 2014/098911 A1 which is provided in the passenger compartment with a sun visor assembly above a front windshield on each of the driver and passenger sides. The sun visor assembly is provided with a surface portion which is provided with a light-inhibiting functional layer which changes the light transmittance for ambient luminous radiation as a function of electrical activation. The light-inhibiting functional layer may take the form of a PDLC film.

The object of the invention is to provide a sun visor assembly and a motor vehicle of the above-mentioned type which enable a lightweight, space-saving but nevertheless effective sun shading system.

This object is achieved for the sun visor assembly in that the visor part has a dimensionally stable frame which surrounds at least one light-transmitting, flexible carrier layer, on which the electrically activatable light-inhibiting functional layer is extensively applied. The light-inhibiting functional layer advantageously takes the form of a PDLC film. Alternatively, the light-inhibiting functional layer may be configured as an SPD film, as an electrochromic layer or as nanotubes applied to a transparent substrate, wherein the nanotubes unroll on electrical activation into a microscopic planar element, so resulting in increased darkening of the transparent substrate, in particular a glass sheet. The flexible carrier layer is advantageously mounted in the frame. Alternatively, the carrier layer may be molded in one piece with a frame part or a frame portion of the frame, in particular it may be injection molded on during production of the frame from a plastics material in an injection molding procedure. In this case, a hard or soft plastics material may be selected, in particular PP or TPU. The light-inhibiting functional layer does not, in contrast, have to be fixed directly in the frame itself, but rather it can merely be held indirectly relative to the frame by way of the mounting of the flexible carrier layer. The flexible carrier layer is preferably mounted flat and taut in the frame, such that the light-inhibiting functional layer applied to the carrier layer is also oriented correspondingly flat in a plane. This gives rise, firstly, to an extremely thin visor part which, secondly, is also very lightweight. The flexible, light-transmitting carrier layer serves as touch protection for the light-inhibiting functional layer. The frame ensures sufficient dimensional stability for the entire visor part. The solution according to the invention is suitable for the interiors of different vehicles for land, water and air transport and serves to provide dazzle protection against luminous radiation which impinges on the vehicle interior from the surrounding environment, i.e., from outside the vehicle. Such luminous radiation may in particular be solar radiation or indeed, at night, the high beam of an approaching vehicle.

In one development of the invention, the carrier layer is configured as a textile woven or knitted fabric which is spanned in the frame. The carrier layer advantageously takes the form of a textile knit fabric. The carrier layer is so wide-meshed that, when the light-inhibiting functional layer is switched to transparent, it is possible to see through the visor part, i.e., it transmits light.

In a further development of the invention, the outer dimensions of the light-inhibiting functional layer are configured to be less than or equal to the inner dimensions of an internal cross-section of the frame. Thus, an outer contour of the light-inhibiting functional layer, preferably of the PDLC film, is matched to an inner contour of the internal cross-section of the frame such that the outer contour of the light-inhibiting functional layer is configured to be at least largely parallel to or level with a peripheral inner surface of an inner edge of the frame. It is essential for the light-inhibiting functional layer itself not to be fastened by its own edge regions to the frame. Instead, the light-inhibiting functional layer is fixed solely by the extensive, preferably bonded connection of the light-inhibiting functional layer to the carrier layer, which is in turn mounted fastened and taut in the frame. The frame peripherally surrounds the light-inhibiting functional layer.

In a further development of the invention, the light-inhibiting functional layer takes the form of a PDLC film. The PDLC (polymer dispersed liquid crystal) film is provided with electrical terminals, which are connected to complementary electrical contacts of the visor part. The electrical contacts of the visor part are supplied by the vehicle electrical system.

In one further development of the invention, the PDLC film is provided with a protective surface on a side remote from the carrier layer. The protective surface reduces soiling of the PDLC film, wherein in particular finger marks are at least largely no longer visible. The protective surface is advantageously a roughened surface. A corresponding outer surface of the PDLC film may in this case be directly roughened, or said surface may be provided with an additional transparent protective film which accordingly has a rough or otherwise textured surface to reduce the visibility of finger marks.

In a further development of the invention, the frame is made at least in portions from an in particular transparent plastics material, and the carrier layer is preferably injection-molded onto at least one frame portion by injection molding. The transparent configuration at least in portions makes it possible to discern the texturing and configuration of the carrier layer through the plastics material of the frame.

In a further development of the invention, the frame has mechanical fixing means which fix an edge of the carrier layer peripherally in the frame. The mechanical fixing means may be provided by mutually complementary plug and socket profiles, which are provided on different halves of a double-shell frame. The plug and socket profiles may be embodied as mutually complementary bars, which extend in portions or over the entire periphery of the frame edge. The flexible carrier layer is clamped fast in simple manner between these plug and socket profiles. The carrier layer may alternatively be provided with holes in its edge region, through which corresponding pegs of the frame penetrate, wherein in this variant too the frame is divided in two and the carrier layer is accommodated between the two frame halves. Corresponding pegs are then associated with the one frame half, while the opposing frame half has complementary sockets, into which the pegs penetrate in force- or form-locking manner. Corresponding holes in the edge region of the carrier layer may be produced by punching or indeed may be burned in, so inevitably stabilizing the corresponding hole edges. Alternatively, the holes in the carrier layer may be reinforced by bushes or hollow rivets. The carrier layer may be single- or multilayered. A multilayer embodiment may advantageously be achieved by appropriate folding and the resultant doubling of the carrier layer.

In a further development of the invention, the frame has electrical contacting elements which are contacted with electrical connecting elements of the light-inhibiting functional layer to activate the light-inhibiting functional layer electrically. This contacting is ensured after fitting and completion of the sun visor assembly. Installation of the sun visor assembly in the vehicle interior brings about connection to the on-vehicle electrical system.

In a further development of the invention, a voltage converter is associated with the frame, which voltage converter converts a DC voltage from a vehicle electrical system into an AC voltage for electrical activation of the light-inhibiting functional layer. This development is advantageous in particular for light-inhibiting functional layers in the form of PDLC films. The development enables low-cost retrofitting of the sun visor assembly to existing vehicles, since all that has to be undertaken is coupling to an on-vehicle 12 V direct current vehicle electrical system, without electrical or electronic components having to be additionally built in to the vehicle. The voltage converter may be integrated in an electronics component which is fastened to the frame. The voltage converter may additionally bring about a change from a 12V voltage to a 48V voltage.

In a further development of the invention, the frame is associated with a sensor system which detects a functional position of the visor part, and a control system is provided which activates or deactivates the light-inhibiting functional layer as a function of detection of the functional position. The light-inhibiting functional layer is advantageously only electrically activatable when the visor part has been displaced into its functional position.

In a further development of the invention, the frame is associated with a sensor system for detecting a light intensity of ambient luminous radiation which is coupled to a control system for controlling the degree of darkening of the light-inhibiting functional layer. In this way, depending on the light intensity of the luminous radiation entering the vehicle interior, the light-inhibiting functional layer is controlled to give a greater or lesser degree of darkening. The control system may be configured separately from or as a unit with the above-described control system for activating the light-inhibiting functional layer.

In a further development of the invention, the visor part is spatially associated with at least one separately produced add-on functional part. An add-on functional part should be understood to mean a functional part which assigns a further function to the sun visor assembly, independently of the light-inhibiting function. A particularly advantageous add-on functional part is a vanity mirror or indeed a light source to illuminate the vanity mirror or another region of the visor part. Spatial association should be understood to mean both attaching the add-on functional part to the visor part, whether movably or stationarily, and positioning it in the immediate vicinity of the visor part but separately from the visor part.

In a further development of the invention, the add-on functional part is mounted swivelably about a swivel axis coaxial with the swivel axis of the visor part. This development allows low assembly effort. In addition, the add-on functional part may be configured in terms of size and shape independently of the visor part. Since the add-on functional part can be moved swivelably separately of the visor part, functioning of the visor part is also not limited by the add-on functional part. Instead, the add-on functional part can simply be swiveled upwards out of the way when the visor part with its light-inhibiting functional layer is in action.

In a further development of the invention, the add-on functional part is arranged on a holder which is fixed to the vehicle. The add-on functional part is preferably arranged detachably on the holder, so that the add-on functional part can, if required, be removed and taken away. This is particularly advantageous if the add-on functional part takes the form of a vanity mirror. The holder may be provided on the visor part or separately to the visor part, but in the immediate vicinity of the visor part. In the immediate vicinity of the visor part means that the holder is secured within the vehicle interior and laterally adjoins the visor part.

In a further development of the invention, the add-on functional part is embodied as a digital display unit. The digital display unit may serve as a carrier of information for a driver or a passenger, advantageously by way of an integrated OLED display switchable between mirrored and transparent. Power is supplied to the digital display unit by wire, advantageously via the visor part's cable guide. Data transmission of corresponding display unit information may take place wirelessly or by wire, if by wire preferably via a LAN cable and if wirelessly preferably via a local radio network provided on-vehicle.

The object underlying the invention is also achieved in that the visor part is guided displaceably along a guide track between the resting position and at least one functional position, and the guide track is arranged, when fitted on the vehicle and in the operating state, parallel to a door frame of a front side door of a motor vehicle. The solution according to the invention provides an occupant of a motor vehicle with a means of lateral dazzle protection, which is moreover displaceable along the guide track in accordance with the position of the sun and may thus follow the sun, whether it is high or low in the sky. The visor part is advantageously displaced manually along the guide track. The visor part is secured in the light-inhibiting position respectively adopted in the guide track, preferably by force-locking guidance within the guide track. The guide track is advantageously configured as a guide rail, which is either installed fixed to the vehicle body in the region of a door aperture in the vehicle body or fixed to the door in the region of a door frame. If it is arranged fixed to the door, the guide rail is swiveled open together with the door when the latter is opened. If it is arranged on the vehicle body, the guide track, in particular the guide rail, remains stationary when the door is opened. The profile of the guide track corresponds at least largely to a contour of the door aperture or the door frame. The visor part may be provided with a carrier layer and a light-inhibiting functional layer, as explained above. Alternatively, the visor part may be embodied in the manner of a conventional sun visor without an electrically activatable light-inhibiting functional layer.

In one development of the invention, in the resting position, the visor part is arranged concealed between the side door and a side region of a vehicle cockpit below the vehicle window sill. Thus, when in its resting position the visor part is invisibly accommodated, such that in the resting position the visor part is not obtrusive in the vehicle interior. The side region of the vehicle cockpit is the region of the vehicle cockpit which adjoins the inside of the adjacent side door.

With regard to the motor vehicle, the object underlying the invention is achieved in that at least one sun visor assembly is provided as described with reference to the above-explained variants.

Further advantages and features of the invention are revealed by the claims and by the following description of preferred exemplary embodiments of the invention, these being explained with reference to the drawings.

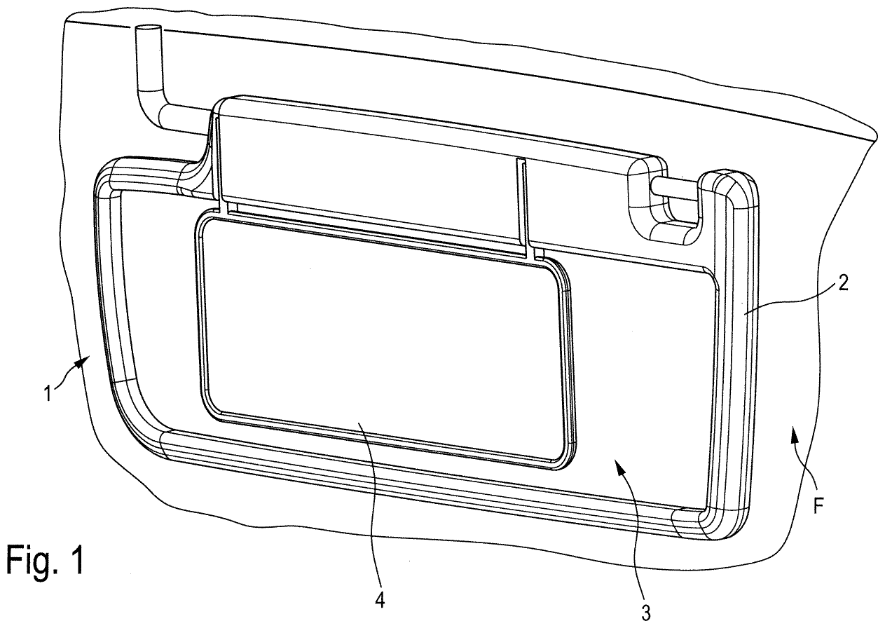

FIG. 1 is a perspective representation of a portion of a vehicle interior in the region of a front windshield with one embodiment of a sun visor assembly according to the invention,

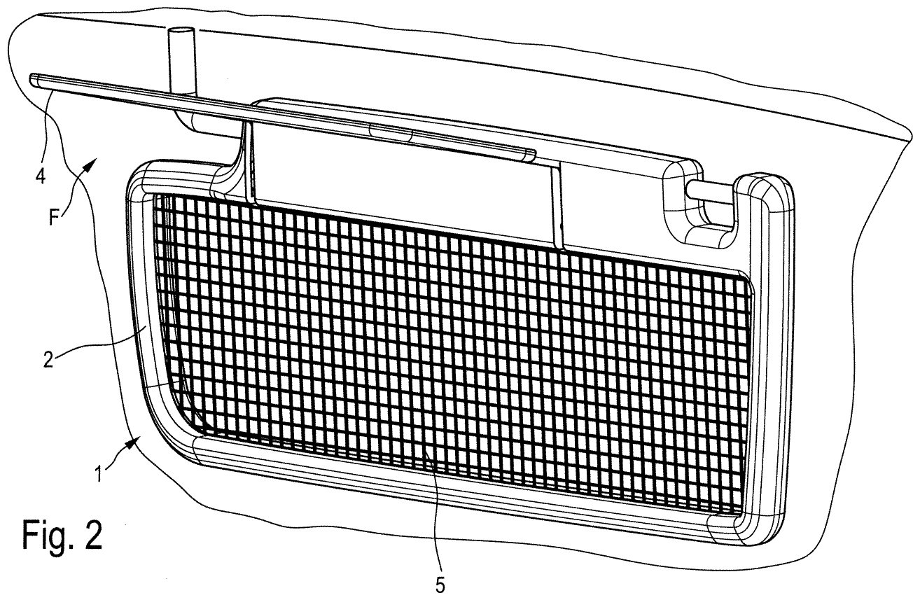

FIG. 2 shows the sun visor assembly according to FIG. 1 in a different functional position,

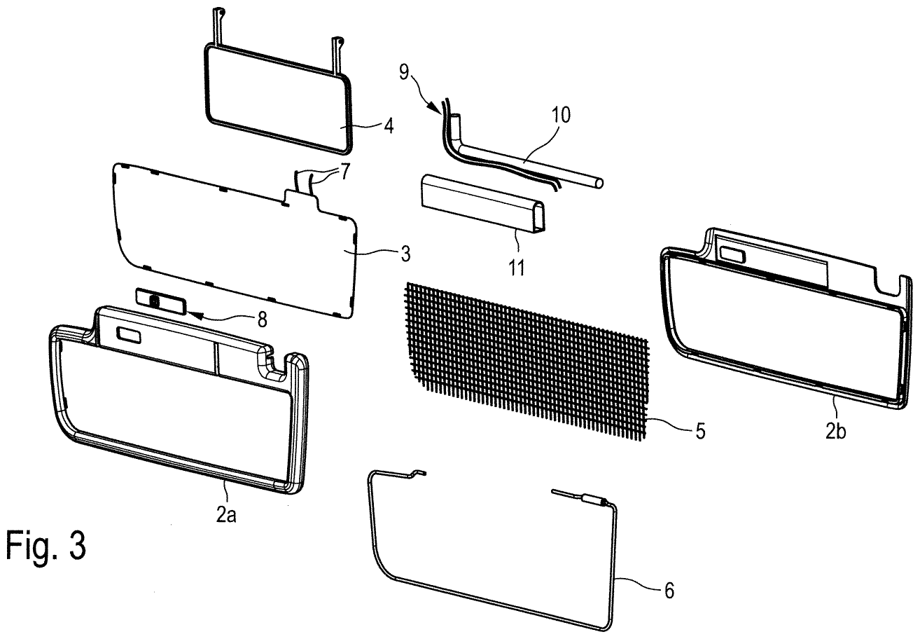

FIG. 3 is a perspective, exploded representation of the sun visor assembly according to FIGS. 1 and 2,

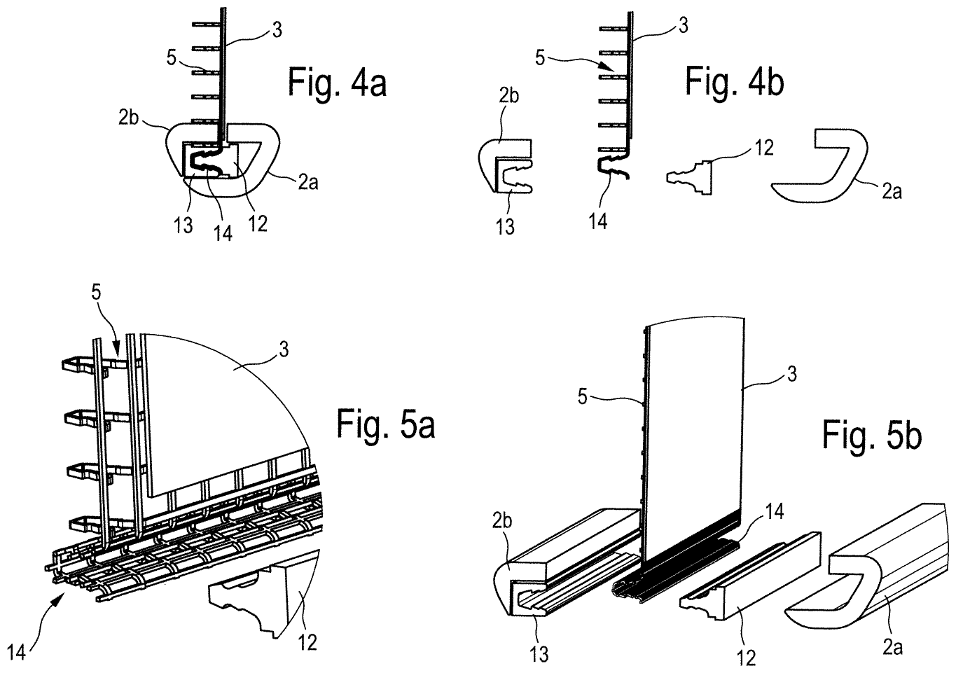

FIG. 4a is a sectional representation of a portion of a visor part of the sun visor assembly according to FIGS. 1 to 3 in the fastening region for a carrier layer,

FIG. 4b shows the portion according to FIG. 4a, but in exploded representation,

FIG. 5a is a perspective representation of the portion according to FIG. 4a,

FIG. 5b is a perspective representation of the exploded view according to FIG. 4b,

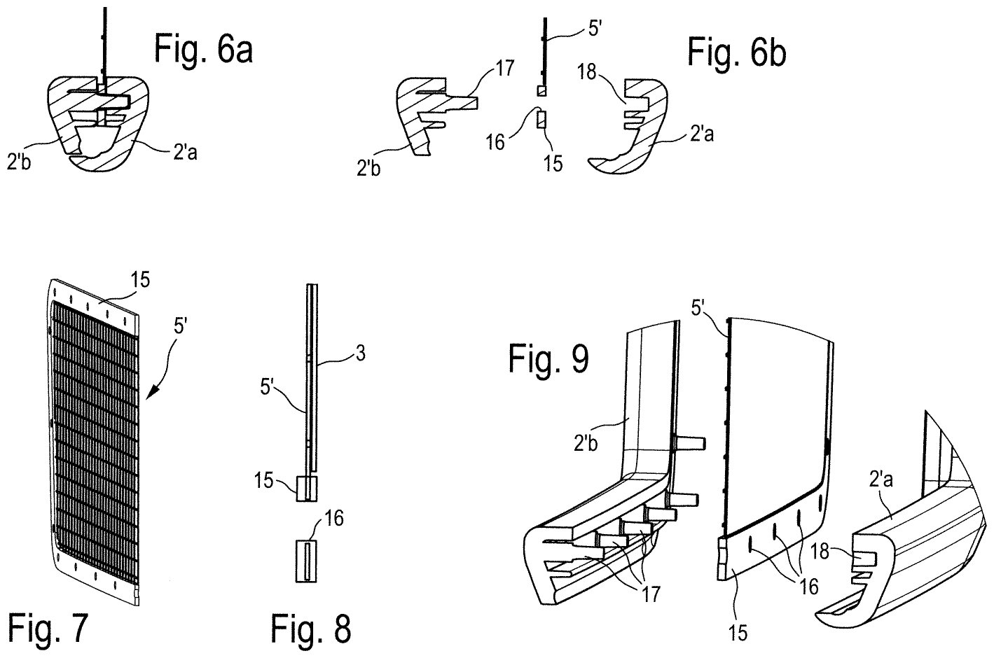

FIG. 6a shows a further embodiment, in a portion similar to FIG. 4a, of a sun visor assembly according to the invention with a different type of fastening for a carrier layer of a visor part,

FIG. 6b shows the portion according to FIG. 6a, in exploded representation,

FIG. 7 is a perspective representation of a sub-region of the carrier layer according to FIGS. 6a and 6b,

FIG. 8 is an enlarged sectional representation of the carrier layer according to FIGS. 6b and 7,

FIG. 9 is an enlarged perspective representation of the portion according to FIG. 6b,

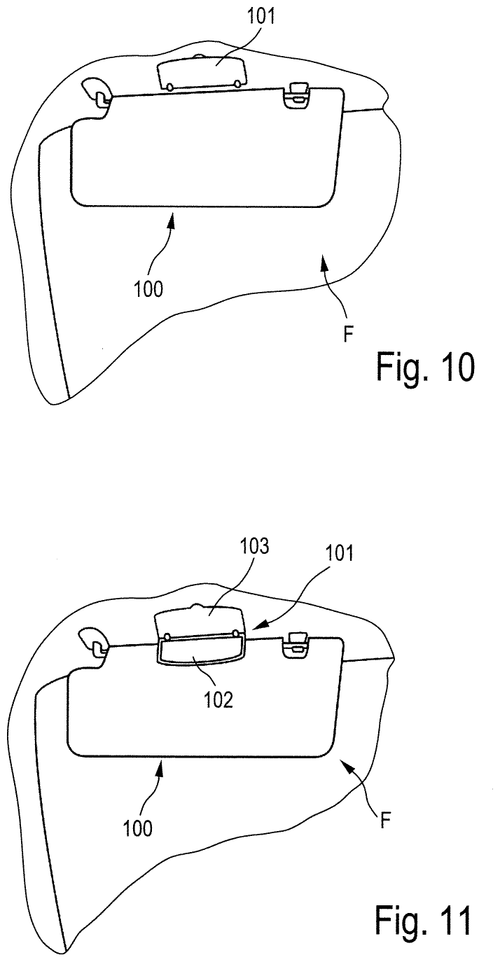

FIG. 10 shows a further embodiment of a sun visor assembly according to the invention in a vehicle interior in a first functional position,

FIG. 11 shows the sun visor assembly according to FIG. 10 in a second functional position,

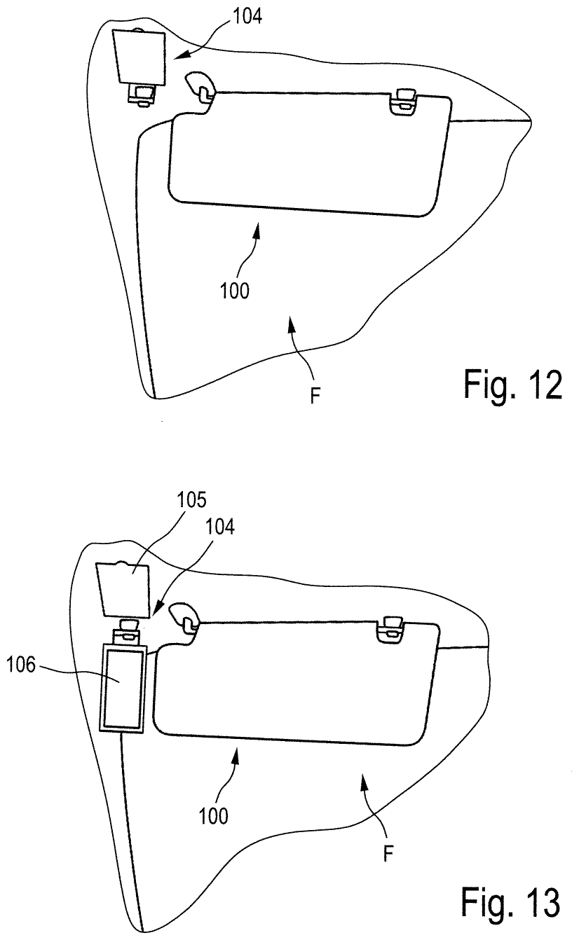

FIG. 12 shows a further embodiment of a sun visor assembly according to the invention in a vehicle interior,

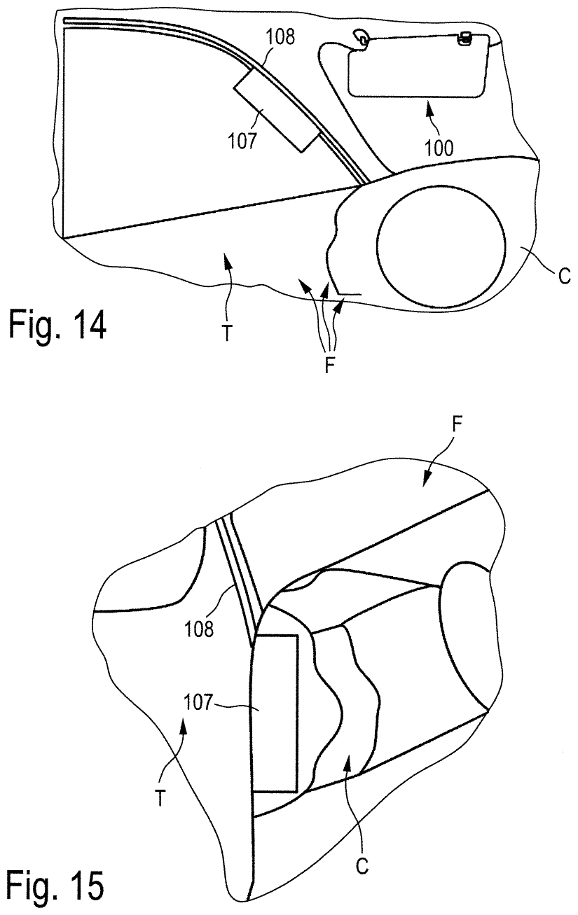

FIG. 13 shows the sun visor assembly according to FIG. 12, but in a different functional position,

FIG. 14 shows a sub-region of a vehicle interior with a further embodiment of a sun visor assembly according to the invention which is provided with an additional lateral visor part,

FIG. 15 is a schematic, perspective representation of accommodation of the lateral visor part in the resting position between a lateral cockpit region and the inside of a side door and

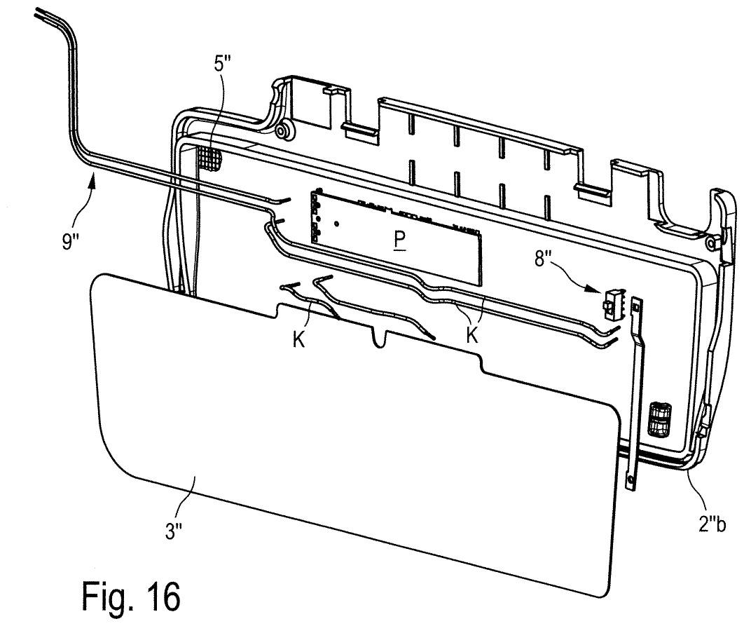

FIG. 16 is an exploded representation of part of a further embodiment of a sun visor assembly according to the invention.

A passenger vehicle has a vehicle interior F, which is delimited at the front by a windshield and on opposing vehicle sides in each case by a side door T. The two side doors T are each fastened swivelably to an A pillar of a vehicle body. The two A pillars bound the windshield on opposing sides. Below the windshield, a vehicle cockpit C is provided in the vehicle interior, which vehicle cockpit C is provided on the driver's side with a steering wheel, as indicated in FIGS. 14 and 15.

As is clear from FIGS. 1 and 2 and 10 to 14, the vehicle interior F of the passenger vehicle has a sun visor assembly 1, 100, 107 above the windshield at least on the driver's side. The sun visor assembly 1, 100 has a visor part which is mounted to the vehicle above the windshield in a roof area of the vehicle interior so as to be swivelable between a resting position, in which the visor part is folded up against the roof region, and a functional position, in which the visor part is swiveled downward in front of the windshield. FIGS. 1 to 15 illustrate various embodiments of sun visor assemblies 1, 100, 107 according to the invention, which are described below in greater detail.

According to FIGS. 1 to 3, the sun visor assembly 1 has a visor part, which is provided with a dimensionally stable frame 2. The frame 2 peripherally surrounds a roughly rectangular free cross-section. The frame 2 is formed by two frame halves 2a and 2b, which are both made in dimensionally stable manner from plastics material. A wire stirrup structure 6 is embedded between the two frame halves 2a and 2b, said structure serving in swivel mounting of an add-on functional part, here a vanity mirror 4.

A light-inhibiting functional layer in the form of a PDLC film 3 is introduced into the free cross-section of the frame 2, said layer being applied extensively to a textile carrier layer 5, here in the form of a textile knit fabric. In its edge region, the PDLC film 3 may additionally also be fixed mechanically in the frame 2 between the two frame halves 2a and 2b. To this end, the PDLC film 3 has to be somewhat larger in its outer dimensions than the free cross-section of the frame 2. A swivel bearing block 10 is additionally provided on-vehicle, to which bearing block the frame 2 is mounted to be swivelable between the resting position and the functional position.

The PDLC film is connected with electrical terminal elements 7, which are connected, when assembled and ready for operation, electrically with electrical contacting elements 9, here in the form of electrical lines. The electrical contacting elements 9 are introduced into the frame 2 along the swivel bearing block 10 and electrically connected to the terminal elements 7. The electrical contacting elements 9 are led off from an on-vehicle electrical system. A tubular cover 11 encloses the electrical contacting elements 9 and the swivel bearing block 10. The cover 11 is firmly connected to the frame 2.

The PDLC film 3 is associated, in a manner not described in any greater detail, with a control system comprising a switching element 8. The control system is activatable on the one hand via a sensor system, which detects a position of the visor part. If the visor part is located in its functional position, electrical activation of the PDLC film 3 is in principle enabled. When the visor part is in the resting position, the PDLC film 3 is electrically uncoupled from the on-vehicle electrical system. On the other hand, the control system is activatable by the electrical switching element 8, which is displaceable in the visor part frame between an active position and a passive position. In the active position, the PDLC film 3 is electrically activated. In the passive position, the PDLC film 3 is deactivated.

Various variants for fixing the PDLC film 3 relative to the frame of the visor part are described in greater detail with reference to FIGS. 4a to 5b and 6a to 9. In the embodiment according to FIGS. 4a to 5d, the frame halves 2a and 2b are each associated with plug and socket profiles 12 and 13, between which the flexible textile carrier layer 5 is clamped in place. The plug and socket profiles 12 and 13 are complementary to one another and configured as plug and socket bars. The two frame halves 2a and 2b, between which the plug and socket profiles 12 and 13 are held, are fixed relative to one another mechanically or in bonded manner, in particular by adhesive bonding or welding.

In the embodiment according to FIGS. 6a to 9, the textile carrier layer 5′ configured as a knit fabric is surrounded by a dimensionally stable edge 15, to which the carrier layer 5′ preferably welded. The edge 15 has a plurality of openings 16 distributed over its periphery, through which plug-in pegs 17 of one half 2′b of a frame 2′ can be inserted. The plug-in pegs 17 engage in sockets 18 in the opposing frame half 2′a. The plug-in pegs 17 and the sockets 18 form plug and socket profiles for the purposes of the invention. The frame halves 2′a and 2′b may be fixed mechanically or in bonded manner relative to one another in the assembled state shown in FIG. 6a. The carrier layer 5′ is thus also inevitably fixed in the frame of the visor part. As is apparent from FIG. 8, the PDLC film 3 is applied extensively to the carrier layer 5′, advantageously by extensive bonding.

In both embodiments according to FIGS. 4a to 9, the PDLC film 3 may additionally be fixed mechanically with its peripheral edge between the frame halves 2a, 2b, 2′a, 2′b as in the variant described with reference to FIG. 3.

In the embodiments according to FIGS. 10 to 13, the respective sun visor assembly 100 is in each case additionally associated with an add-on functional part 101, 104 in the form of a vanity mirror. Here, said association is not implemented by direct mounting of the add-on functional part to the frame of the visor part, as is shown with reference to FIGS. 1 to 3; instead it is mounted separately of the sun visor assembly 100 but directly adjacent thereto. The add-on functional part 101 is secured above the sun visor assembly 100 in the roof region of the vehicle interior F. To this end, a support part 103 fitted fixedly to the roof and a swivelable part 102 comprising a vanity mirror are provided, the latter being coupled swivelably to the carrier part 103. The vanity mirror may be made usable by folding open the swivelable part 102. In the closed position according to FIG. 10, the swivelable part 102 is placed against the support part 103.

In the embodiment according to FIGS. 12 and 13, the add-on functional part 104 is positioned to the side of the sun visor assembly 100 in the roof region of the vehicle interior F. Here too, a holder part 105 is provided, which is secured to the roof. The holder part 105 is associated with a swivel bearing arrangement, which allows detachable swivel mounting of the swivelable part 106. The swivelable part 106 is provided with the vanity mirror. The swivelable part 106 is accordingly removable by disengagement from the swivel bearing arrangement and reconnectable with the swivel bearing arrangement and thus with the holder part 105 by corresponding snapping-in.

In the embodiment according to FIGS. 14 and 15, the sun visor assembly 100 is additionally also associated with lateral dazzle protection. To this end, a visor part 107 is provided which is mounted so as to be displaceable along a guide rail 108 between a lower resting position, shown in FIG. 15, and any desired functional position, an example of which is shown in FIG. 14. The guide rail 108 is attached to a door frame of the side door T and extends parallel to a window aperture of the side door T obliquely up and back from a vehicle window sill. The guide rail 108 additionally extends along the inside of the side door T as far as below the vehicle window sill, such that, when the side door T is closed, the guide rail 108 extends as far as into a side region of the vehicle cockpit C. The visor part 107 is provided with guide sliders, not described in any greater detail, which enable the visor part 107 to slide in the guide rail 108. The guide sliders are guided force-lockingly in the guide rail 108 in such a way that the visor part 107 can be slid by hand along the guide rail 108, but remains in the respectively adjusted functional position when the manual load is removed, due to its force-locking engagement. In the resting position according to FIG. 15, the visor part 107 has been slid in the guide rail 108 in such a way that it is positioned concealed between the lateral region of the vehicle cockpit C and the inside of the side door T.

A sun visor assembly according to FIG. 16 corresponds in fundamental structure to a sun visor assembly as described with reference to FIGS. 1 to 3. To avoid repetition, reference is thus made for completeness to the explanations relating to FIGS. 1 to 3. The frame of the sun visor assembly according to FIG. 16 is of two-part construction, just one frame half 2″b being shown. Functionally identical parts or portions are provided with the same reference signs, with the addition of a double-prime symbol.

The essential difference in the sun visor assembly according to FIG. 16 is that the carrier layer 5″ therein has been injection-molded directly onto the frame part 2″b, as is apparent from the portion depicted in FIG. 16. Here, the carrier layer 5″ has been molded on by injection molding during production of the frame half 2″b, such that the carrier layer 5″ is connected around the periphery in one piece with the frame half 2″b. The light-inhibiting functional layer, here likewise in the form of a PDLC film 3″, has been applied extensively to the carrier layer 5″ as in the embodiment according to FIGS. 1 to 3. The electrical contacting elements 9″ are led off from an on-vehicle electrical system as in the embodiment according to FIGS. 1 to 3. Further electrical contact lines K are installed in the frame and, on the one hand, connect electrical terminals of the PDLC film 3″ to an electronic component P, which has likewise been integrated in the frame. The electronic component P has an electronic circuit board, to which different electronic parts are attached in a manner not described in any more detail, these parts also including a voltage converter. Further electrical contact lines K extend between a switching element 8″ and the electronics component P or the electrical contacting elements 9″.

1. A sun visor assembly for a vehicle interior, the sun visor assembly comprising a visor part arranged to be displaceable between a functional position and a resting position, the visor part having an electrically activatable light-inhibiting functional layer, at least one light-transmitting, flexible carrier layer, and a dimensionally stable frame surrounding the at least one light-transmitting, flexible carrier layer, the electrically activatable light-inhibiting functional layer being extensively applied onto the carrier layer.

2. The sun visor assembly as claimed in claim 1, wherein the carrier layer is configured as a knitted fabric, the knitted fabric spanning the frame.

3. The sun visor assembly as claimed in claim 1, wherein the carrier layer is molded in one piece on the frame.

4. The sun visor assembly as claimed in claim 1, wherein outer dimensions of the light-inhibiting functional layer are less than or equal to inner dimensions of an internal cross-section of the frame.

5. The sun visor assembly as claimed in claim 1, wherein the light-inhibiting functional layer comprises a PDLC film.

6. The sun visor assembly as claimed in claim 4, wherein the PDLC film comprises a protective surface on a side remote from the carrier layer.

7. The sun visor assembly as claimed in claim 1, wherein the frame has at least one frame portion comprising an in particular transparent plastics material, and the carrier layer is preferably injection-molded onto the at least one frame portion by injection molding.

8. The sun visor assembly as claimed in claim 1, wherein the frame comprises mechanical fixing means for fixing an edge of the carrier layer peripherally in the frame.

9. The sun visor assembly as claimed in claim 1, wherein the frame has electrical contacting elements in contact with electrical connecting elements of the light-inhibiting functional layer to activate the light-inhibiting functional layer electrically.

10. The sun visor assembly as claimed in claim 9, wherein a voltage converter is associated with the frame, the voltage converter converting a DC voltage from a vehicle electrical system into an AC voltage for electrical activation of the light-inhibiting functional layer.

11. The sun visor assembly according to claim 1, further comprising a sensor system, the frame being associated with the sensor system, the sensor system detecting a functional position of the visor part, the sun visor assembly further comprising a control system activating or deactivating the light-inhibiting functional layer as a function of detection of the functional position by the sensor system.

12. The sun visor assembly according to claim 1, further comprising a sensor system, the frame being associated with the sensor system, the sensor system being configured for detecting a light intensity of ambient luminous radiation, the sun visor assembly further comprising a control system for controlling a degree of darkening of the light-inhibiting functional layer, the sensor system being coupled to the control system.

13. The sun visor assembly as claimed in claim 1, wherein the visor part is spatially associated with at least one separately produced add-on functional part.

14. The sun visor assembly as claimed in claim 13, wherein the add-on functional part is mounted swivelably about a swivel axis coaxial with a swivel axis of the visor part.

15. The sun visor assembly as claimed in claim 13, wherein the add-on functional part is arranged on a holder fixed to the vehicle.

16. The sun visor assembly as claimed in claim 13, wherein the add-on functional part comprises a digital display unit.

17. The sun visor assembly according to claim 1, further including a guide track, the visor part being guided displaceably along the guide track between the resting position and the functional position, and the guide track is arranged, when fitted on the vehicle and in an operating state, parallel to a door frame of a front side door of a vehicle.

18. The sun visor assembly as claimed in claim 17, wherein, in the resting position, the visor part is arranged concealed between the front side door and a side region of a vehicle cockpit below a vehicle window sill.

19. A motor vehicle having a least one sun visor assembly as claimed in claim 1.

20. The sun visor assembly as claimed in claim 1, wherein the carrier layer is configured as a textile woven fabric.

21. A sun visor assembly for a vehicle interior, the sun visor assembly comprising a visor part arranged to be displaceable between a functional position and a resting position, the visor part having an electrically activatable light-inhibiting functional layer, a frame, and at least one light-transmitting, flexible carrier layer, the sun visor assembly further comprising a sensor system detecting a functional position of the visor part, the frame being associated with the sensor system, and a control system, the control system activating or deactivating the light-inhibiting functional layer as a function of detection of the functional position by the sensor system.

22. A sun visor assembly for a vehicle interior, the sun visor assembly comprising a visor part arranged to be displaceable between a functional position and a resting position, the visor part having an electrically activatable light-inhibiting functional layer, a frame, and at least one light-transmitting, flexible carrier layer, the sun visor assembly further comprising a sensor system detecting a functional position of the visor part, the frame being associated with the sensor system, and a control system for controlling a degree of darkening of the light-inhibiting functional layer, the sensor system being coupled to the control system.

23. A sun visor assembly for a vehicle interior, the sun visor assembly comprising a guide track and a visor part arranged to be displaceable between at least one functional position and a resting position, the visor part having an electrically activatable light-inhibiting functional layer and being guided displaceably along the guide track between the resting position and the at least one functional position, and the guide track is arranged, when fitted on a vehicle and in an operating state, parallel to a door frame of a front side door of the vehicle.

24. The sun visor assembly as claimed in claim 1, wherein the carrier layer is mounted on the frame so as to substantially occupy a plane, and the light-inhibiting functional layer is connected to the carrier layer over substantially an entirety of the plane of the carrier layer.

25. The sun visor assembly as claimed in claim 1, wherein the light-inhibiting functional layer is connected to the carrier layer and is superimposed over the carrier layer over substantially an entire extent of the carrier layer.
